(19) United States
(12) Patent Application Publication
(10) Pub. No.: US 2025/0230977 A1
(43) Pub. Date: Jul. 17, 2025

(54) HEAT TREATMENT APPARATUS

(71) Applicant: Noritake Co., Limited, Nagoya-shi (JP)

(72) Inventors: Hidenori Nakamura, Nagoya-shi (JP); Hideaki Ohi, Nagoya-shi (JP); Masaki Iida, Nagoya-shi (JP)

(73) Assignee: Noritake Co., Limited, Nagoya-shi (JP)

(21) Appl. No.: 19/017,032

(22) Filed: Jan. 10, 2025

(30) Foreign Application Priority Data
Jan. 11, 2024 (JP) 2024-002836

(51) Int. Cl. F26B 13/18

(52) U.S. Cl. CPC F26B 13/183

(57) ABSTRACT

A heat treatment apparatus includes a conveyance device, an unwinding unit, a heat treatment unit, and a winding unit. The conveyance device conveys a strip-shaped workpiece. The unwinding unit unwinds the workpiece. The heat treatment unit has therein a processing space where the unwound workpiece is heat-treated. The winding unit winds up the processed workpiece. At least one of the unwinding unit and the winding unit includes a pair of retainers and a pair of support parts. The pair of retainers retains a core of a roll, on which the workpiece is wound, from both sides thereof in an axial direction. The pair of support parts receives end portions of the core, below both end portions of the core retained by the retainers.

### CROSS REFERENCE TO RELATED APPLICATION(S)

This application claims the benefit of priority to Japanese Patent Application No. 2024-002836 filed on Jan. 11, 2024, the entire contents of which are hereby incorporated herein by reference.

### BACKGROUND OF THE DISCLOSURE

The present disclosure relates to a heat treatment apparatus.

Japanese Patent Publication No. 7285360 discloses a heat treatment apparatus that includes an unwinding unit, a heat treatment unit, a cooling unit, and a winding unit. A strip-shaped sheet is unwound from the unwinding unit before heat treatment. In the heat treatment unit, the sheet is heat-treated while being conveyed. In the cooling unit, the sheet heat-treated in the heat treatment unit is cooled while being conveyed. In the winding unit, the strip-shaped sheet cooled in the cooling unit is wound thereon. In the unwinding unit and winding unit, an unwinding roll for unwinding the strip-shaped sheet, i.e., workpiece, and a winding roll for winding the sheet-shaped workpiece are replaced with new ones as necessary.

### SUMMARY

The present inventors intend to improve the workability of roll replacement.

A heat treatment apparatus disclosed herein includes: a conveyance device, an unwinding unit, a heat treatment unit, and a winding unit. The conveyance device conveys a strip-shaped workpiece. The unwinding unit unwinds the workpiece. The heat treatment unit performs heat treatment on the unwound workpiece while the workpiece is conveyed along a predetermined conveyance route. The winding unit winds the heat-treated workpiece. At least one of the unwinding unit and the winding unit includes a pair of retainers and a pair of support parts. The pair of retainers retains a core of a roll on which the workpiece is wound, from both sides thereof in an axial direction. The pair of support parts receives respective end portions of the core, below both the end portions of the core retained by the pair of retainers. The heat treatment apparatus with this configuration has enhanced workability of roll replacement.

### BRIEF DESCRIPTION OF THE DRAWINGS

FIG. 1 is a schematic diagram illustrating a heat treatment apparatus 10.

FIG. 2 is a schematic diagram illustrating an unwinding unit 30.

FIG. 3 is a schematic diagram illustrating a retaining structure of a core A2.

FIG. 4 is a perspective view of a support part 40.

### DETAILED DESCRIPTION OF THE INVENTION

One embodiment in the present disclosure will be described in detail below with reference to the drawings. In the following drawings, members and portions that have the same actions are denoted by the same symbols. The dimensional relationships (length, width, thickness, etc.) in each drawing do not reflect the actual dimensional relationships. The directions of up, down, left, right, front, and back are represented are represented by arrows U, D, L, R, F, and Rr, respectively, in the figures. Here, the directions of up, down, left, right, front, and back are only provided for convenience of explanation and do not limit the present disclosure unless otherwise specifically mentioned.

### <Heat Treatment Apparatus 10>

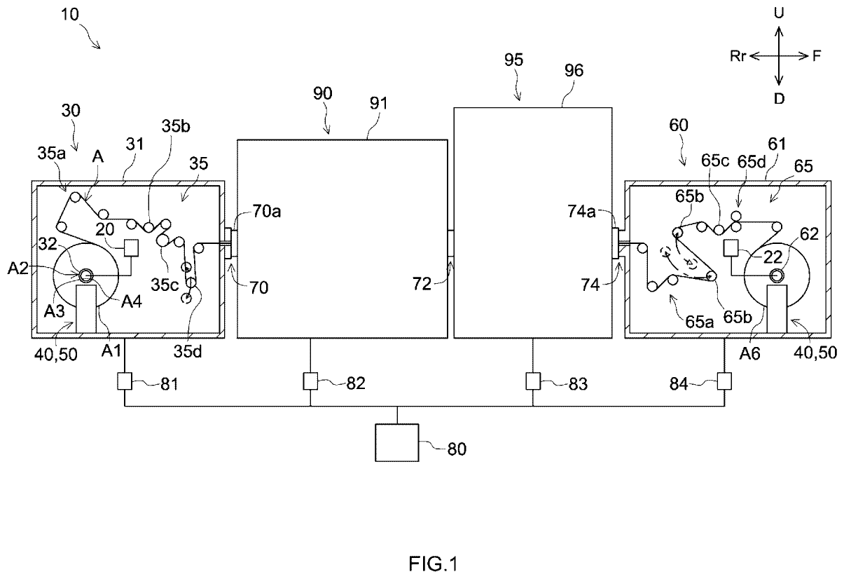

FIG. 1 is a schematic diagram illustrating a heat treatment apparatus 10. The heat treatment apparatus 10 is equipment for performing heat treatment on a strip-shaped (sheet-shaped) workpiece A, which is an object to be processed. In this embodiment, the heat treatment apparatus 10 is a device for continuously drying a strip-shaped workpiece while conveying it in a so-called roll-to-roll system. The workpiece A is not particularly limited as long as it is a strip-shaped object, such as an electrode sheet for secondary batteries that has an electrode material applied to both sides of a sheet base, a Flexible Copper Clad Laminate (FCCL), or a polyimide sheet. The heat treatment apparatus 10 can be used to perform the treatment on a variety of strip-shaped (sheet-shaped) workpieces.

As illustrated in FIG. 1, the heat treatment apparatus 10 includes an unwinding unit 30, a heat treatment unit 90, and a winding unit 60.

In this embodiment, the heat treatment apparatus 10 further includes a drive device 100. The heat treatment apparatus 10 also includes a cooling unit 95 between the heat treatment unit 90 and the winding unit 60.

The strip-shaped workpiece A is processed while being conveyed, through the unwinding unit 30, the heat treatment unit 90, the cooling unit 95, and the winding unit 60 in this order. The workpiece A is unwound from an unwinding roll A1 provided in the unwinding unit 30, heat-treated in the heat treatment unit 90, cooled in the cooling unit 95, and then wound onto a winding roll A6 provided in the winding unit 60.

### <Conveyance Devices 20 and 22>

Conveyance devices 20 and 22 are devices that convey the workpiece A. The workpiece A is conveyed along a predetermined conveyance route. The conveyance devices 20 and 22 rotationally drive an unwinding shaft 32, on which the unwinding roll A1 of the unwinding unit 30 is attached, and a winding shaft 62, on which the winding roll A6 of the winding unit 60 is attached, respectively. Each of the conveyance devices 20 and 22 can be constituted of a device that controls the conveyance of the workpiece A. For example, a motor and an inverter may be used as the conveyance devices 20 and 22, and particularly a servo motor or the like may be used.

The conveyance devices 20 and 22 may include a device that controls a tension applied to the workpiece A. For example, a powder clutch may be used as the device for controlling the tension. The conveyance devices 20 and 22 may be implemented by a system in which a device for controlling the conveyance speed and a device for controlling the tension cooperate with each other.

The unwinding shaft 32 is connected to the conveyance device 20. The unwinding shaft 32 is rotationally driven by the conveyance device 20, thereby unwinding the workpiece A from the unwinding roll A1. The winding shaft 62 is connected to the conveyance device 22. The winding shaft 62 is rotationally driven by the conveyance device 22, thereby winding the workpiece A onto the winding roll A6. The conveyance devices 20 and 22 may be installed in an atmospheric box provided in a space enclosed by outer walls 31 and 61, respectively.

The heat treatment apparatus 10 can be configured to convey the workpiece A at a high speed in order to improve the processing efficiency of the workpiece A. Although not particularly limited, the conveyance speed of the workpiece A can be set to about 1 m/min to 200 m/min. In this embodiment, the conveyance speed of the workpiece A is set to about 100 m/min.

In the heat treatment apparatus 10, the conveyance speed of the workpiece A is controlled by a controller (not illustrated).

The controller controls the conveyance speed of the workpiece A, the tension applied to the workpiece A, and the like such that the workpiece A is conveyed according to a predetermined conveyance condition. The controller respectively controls an unwinding tension applied when the workpiece A is unwound, an in-furnace tension applied to the workpiece A being processed, and a winding tension applied when the processed workpiece A is wound up. The controller is connected to the conveyance devices 20 and 22. The controller may be connected to a tension detection roller 35b, a feed roller 35c, a dancer roller 35d, a tension detection roller 65c, and the like. The controller feeds back the unwinding tension detected by the tension detection roller 35b to the conveyance device 20 and thereby controls the torque of the unwinding shaft 32. Thus, the unwinding tension is adjusted. The controller also feeds back, to the dancer roller 35d, the in-furnace tension detected by the tension detection roller 35b, over which the workpiece A being processed is hung. The dancer roller 35d moves according to the detected in-furnace tension. Thus, the in-furnace tension is adjusted. The rotation speed of the feed roller 35c is controlled such that the position of the dancer roller 35d returns to a reference position with the in-furnace tension being constant. The controller feeds back the winding tension detected by the tension detection roller 65c to the conveyance device 22 and thereby controls the torque of the winding shaft 62. Thus, the winding tension is adjusted.

### <Unwinding Unit 30>

The unwinding unit 30 is equipment that unwinds the workpiece A. The unwinding unit 30 houses the unwinding roll A1 in a state where the workpiece A before the heat treatment is wound thereon.

The unwinding unit 30 has the outer wall 31 that encloses internal equipment and the unwinding roll A1. The unwinding unit 30 includes therein the unwinding shaft 32 and plural rollers 35. The unwinding shaft 32 is a shaft to which the unwinding roll A1, holding the workpiece A wound on it before heat treatment, is attached. In this embodiment, the unwinding shaft 32 is rotationally driven to unwind the workpiece A from the unwinding roll A1 attached to the unwinding shaft 32.

Within the space enclosed by the outer wall 31 of the unwinding unit 30, plural rollers 35 are provided to set the conveyance route for the workpiece A. The workpiece A unwound from the unwinding roll A1 is hung around the plural rollers 35 in a predetermined order and conveyed toward the heat treatment unit 90.

The plural rollers 35 include guide rollers 35a, the tension detection roller 35b, the feed roller 35c, and the dancer roller 35d. The tension detection roller 35b is a roller for detecting the tension applied to the workpiece A. A tension detector (not illustrated) is attached to the tension detection roller 35b. The dancer roller 35d is configured to be movable within a predetermined range. By moving the dancer roller 35d, the tension applied to the workpiece A is adjusted. The feed roller 35c is rotationally driven by a drive device (not illustrated). By controlling the rotation of the feed roller 35c, the position of the dancer roller 35d is adjusted.

### <Heat Treatment Unit 90>

The heat treatment unit 90 is equipment where the strip-shaped workpiece A is heat-treated while being conveyed. The heat treatment unit 90 is connected to the unwinding unit 30 via a connecting part 70. The connecting part 70 is provided with an outlet for the unwinding unit 30 and an inlet for the heat treatment unit 90.

Although a detailed illustration is omitted, the heat treatment unit 90 may include a furnace body (outer wall) 91, a heater, and guide rollers. In the heat treatment unit 90, the unwound workpiece A is heat-treated while being conveyed along the predetermined conveyance route. The heat treatment unit 90 has therein a processing space where the unwound workpiece A is heat-treated while being conveyed. The furnace body 91 encloses the processing space in which the heater and the guide rollers are disposed.

The conveyance route along which the workpiece A is conveyed is set by the guide rollers. The guide roller is configured to rotate in a driven manner as the workpiece A is conveyed.

The heater is equipment for heating the workpiece A. The workpiece A is heat-treated by the heater while being conveyed in the conveyance route set by the guide rollers. Note that the configuration of the heat treatment unit 90, including the guide rollers, the heater, and the like, is not particularly limited. The heat-treated workpiece A is conveyed out toward the cooling unit 95.

### <Cooling Unit 95>

The cooling unit 95 is equipment in which the workpiece A heat-treated in the heat treatment unit 90 is cooled while being conveyed. The cooling unit 95 is connected to the heat treatment unit 90 via a connecting part 72. The connecting part 72 is provided with an outlet for the heat treatment unit 90 and an inlet for the cooling unit 95.

Although a detailed illustration is omitted, the cooling unit 95 may include a cooling roller, plural guide rollers, and an outer wall 96. The cooling unit 95 may be provided with plural cooling rollers. The outer wall 96 encloses a processing space in which the plural cooling rollers and the plural guide rollers are disposed. The cooling rollers and the guide rollers set a conveyance route along which the workpiece A is conveyed in the cooling unit 95.

The cooling roller is a roller configured to allow the circulation of a refrigerant. The workpiece A is cooled by contacting a surface of the cooling roller. The cooling roller may be connected to a drive device (not illustrated). The cooling roller can rotate along the conveyance direction at a set conveyance speed.

In this embodiment, the workpiece A is cooled to about room temperature in the cooling unit 95. The temperature to which the workpiece A is cooled is not particularly limited. Note that the configuration of the cooling unit 95, including the guide rollers, the cooling rollers, and the like, is not particularly limited.

The cooled workpiece A is conveyed to the winding unit 60 through a connecting part 74. The cooling unit 95 does not necessarily have to be provided in the heat treatment apparatus 10.

### <Winding Unit 60>

The winding unit 60 is equipment that winds up the processed workpiece A. The winding unit 60 houses the winding roll A6 for winding up the workpiece A that has been cooled through the cooling roller.

The winding unit 60 has the outer wall 61 that encloses internal equipment and the winding roll A6. The winding unit 60 includes a winding shaft 62 and plural rollers 65. The winding shaft 62 has the winding roll A6 attached thereto to wind up the workpiece A, which has been heat-treated in the heat treatment unit 90 and cooled in the cooling unit 95. By rotationally driving the winding shaft 62, the workpiece A is wound onto the winding roll A6.

Within the space enclosed by the outer wall 61 of the winding unit 60, the plural rollers 65 that set the conveyance route for the workpiece A are provided. The plural rollers 65 set a conveyance route along which the workpiece A is conveyed within the winding unit 60. The workpiece A conveyed from the cooling unit 95 is hung over the roller 65 near the inlet (connecting part 74) for the winding unit 60, then hung around the plural rollers 65 in the predetermined order, and eventually wound onto the winding roll A6. The plural rollers 65 include guide rollers 65a, a dancer roller 65b, the tension detection roller 65c, and feed rollers 65d. The dancer roller 65b is configured to be movable within a predetermined range. The dancer roller 65b can be moved, for example, to secure a necessary extra length of the workpiece A when the winding roll A6 is replaced. A tension detector (not illustrated) is attached onto the tension detection roller 65c. The feed roller 65d feeds out the necessary extra length of the workpiece A for attachment to the new winding roll A6 after the replacement of the winding roll A6.

### <Vacuum Pump 80>

The heat treatment apparatus 10 includes a vacuum pump 80. Interior spaces of the unwinding unit 30, the heat treatment unit 90, the cooling unit 95, and the winding unit 60 described above are enclosed by the outer walls 31, 91, 96, and 61, respectively. The unwinding unit 30, the heat treatment unit 90, the cooling unit 95, and the winding unit 60 have respective spaces isolated from an external space by the outer walls 31, 91, 96, and 61, respectively. The spaces inside the outer walls 31, 91, 96, and 61 communicate with each other when the workpiece A is processed. The vacuum pump 80 is connected to each of the outer walls 31, 91, 96, and 61 of the respective units.

The vacuum pump 80 reduces the pressure in the interior spaces of the unwinding unit 30, the heat treatment unit 90, the cooling unit 95, and the winding unit 60 (the processing spaces in the heat treatment unit 90 and the cooling unit 95). In this embodiment, the workpiece A is processed under a predetermined vacuum atmosphere with a pressure lower than atmospheric pressure.

The connection form of the vacuum pump 80 is not particularly limited. Plural vacuum pumps 80 may be provided, and the respective vacuum pumps 80 may be connected to the unwinding unit 30, the heat treatment unit 90, the cooling unit 95, and the winding unit 60. Alternatively, pipes may be branched from one vacuum pump 80 to reduce the pressure inside some of the unwinding unit 30, the heat treatment unit 90, the cooling unit 95, and the winding unit 60.

The pipe of the vacuum pump 80 is provided with vacuum valves 81 to 84 for adjusting the vacuum level in each unit.

The vacuum valves 81 to 84 are configured to be switchable between the connection of each unit to the vacuum pump 80 and the disconnection of each unit from the vacuum pump 80. In a case where the vacuum level of each unit does not need to be adjusted, open/close valves may be used instead of the vacuum valves 81 to 84.

When the rolls are replaced in the unwinding unit 30 and the winding unit 60, these units are exposed to atmosphere by an atmospheric release valve (not illustrated). The atmospheric relief valves may also be provided in the heat treatment unit 90 and the cooling unit 95.

A door 70a is provided at the inlet of the heat treatment unit 90 (in this embodiment, the connecting part 70). The door 70a is closed when replacing the unwinding roll A1 or the like. By closing the door 70a when replacing the unwinding roll A1 or the like, the atmosphere of the heat treatment unit 90 (in this embodiment, a reduced pressure state) can be maintained. The door 70a may be closed when the workpiece A passes through the connecting part 70, such as when the unwinding roll A1 is replaced. When the remaining workpiece A on the unwinding roll A1 is nearly depleted, the unwinding roll A1 is replaced with a new one. The end of a workpiece A on the newly installed unwinding roll A1 after the replacement and the end of the workpiece A from the previous roll before the replacement are coupled together. With the workpiece A remaining in the processing space, the unwinding roll A1 can be replaced while maintaining the atmosphere in the heat treatment unit 90, allowing for a quick recovery of the apparatus after the replacement of the unwinding roll A1.

A door 74a is provided at an outlet of the cooling unit 95 (in this embodiment, the connecting part 74). Like the door 70a, the door 74a can maintain the atmosphere (in this embodiment, the reduced pressure state) in the cooling unit 95 by closing the door 74a when replacing the winding roll A6 or the like. The door 74a may be closed when the workpiece A passes through the connecting part 74, such as when the winding roll A6 is replaced. When the amount of workpiece A wound on the winding roll A6 becomes significant, the winding roll A6 is replaced with a new one. A leading edge of the newly installed winding roll A6 after the replacement and the end of the workpiece A are coupled together. With the workpiece A remaining in the processing space, the winding roll A6 can be replaced while maintaining the atmosphere in the cooling unit 95, allowing for a quick recovery of the apparatus after the replacement of the winding roll A6.

The heat treatment apparatus 10 is not limited to a vacuum furnace that processes the workpiece A under the vacuum atmosphere, but it may also be an atmosphere furnace that processes the workpiece A under a predetermined atmosphere, or an atmospheric furnace that processes the workpiece under an atmospheric environment.

The heat treatment apparatus in which a strip-shaped workpiece is heat-treated while being conveyed includes the unwinding unit that unwinds the workpiece and the winding unit that winds the workpiece. The unwinding unit houses the unwinding roll before the heat treatment. The workpiece is unwound from the unwinding unit, heat-treated in the heat treatment unit, and then wound by the winding unit. The winding unit houses the winding roll after the heat treatment. The workpiece is moved from the unwinding unit to the winding unit as the heat treatment progresses. As the workpiece is unwound, the diameter of a combination of the unwinding roll and the workpiece gradually decreases. On the other hand, as the workpiece is wound up, the diameter of a combination of the winding roll and the workpiece gradually increases. After completing the process of a predetermined amount of workpiece, the unwinding roll and the winding roll are replaced. For example, the unwinding roll and the winding roll are replaced when the amount of workpiece remaining on the unwinding roll becomes small or when the amount of workpiece wound on the winding roll becomes large. The unwinding roll and the winding roll may be replaced at the same time or at different times. The heavier the unwinding roll and the winding roll are, the more burdensome a roll replacement operation may become. In some cases, the tip of the workpiece unwound from the replaced unwinding roll is intended to be coupled to the preceding workpiece, thereby winding the workpieces unwound from the plural unwinding rolls, onto a single winding roll.

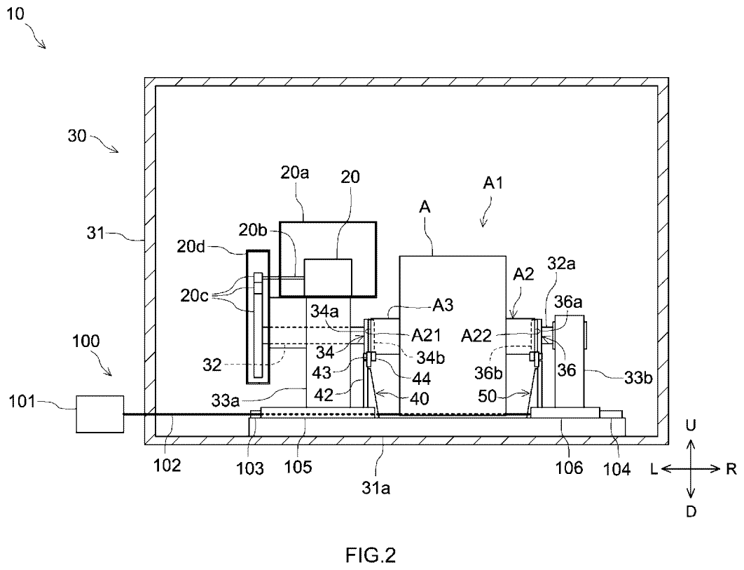

FIG. 2 is a schematic diagram illustrating the unwinding unit 30. As illustrated in FIG. 2, in the heat treatment apparatus 10 disclosed herein, the unwinding unit 30 includes a pair of retainers 34 and 36, and a pair of support parts 40 and 50. Like the unwinding unit 30, the winding unit 60 includes a pair of retainers and a pair of support parts 40 and 50 (see FIG. 1). The configurations of the unwinding unit 30 and the winding unit 60 will be described below by using the unwinding unit 30 as an example. The winding unit 60 can be configured in the same manner as the unwinding unit 30, and thus a detailed description thereof is omitted.

In the unwinding roll A1 housed in the unwinding unit 30, the workpiece A is wound on a core A2. The core A2 has a substantially cylindrical shape. The length of the core A2 is longer than the width of the workpiece A in the left-right direction. The workpiece A before processing is wound overlapping itself around an outer circumferential surface A3 of the core A2.

### <Pair of Retainers 34 and 36>

The pair of retainers 34 and 36 serves as members that retain the core A2 in a roll form, on which the workpiece A is wound, from both sides thereof in the axial direction. The retainers 34 and 36 in a pair are opposed to each other in the width direction of the unwinding unit 30 (in the left-right direction). The retainer 34 retains a left end portion A21 of the core A2. The retainer 36 retains a right end portion A22 of the core A2.

The retainer 34 is connected to the unwinding shaft 32 that is rotationally driven by the conveyance device 20. In this embodiment, the conveyance device 20 is housed in an atmospheric box 20a provided in the outer wall 31. The interior of the atmospheric box 20a is maintained at atmospheric pressure even while the workpiece A is being processed or the vacuum pump 80 is operating. The power of the conveyance device 20 is transmitted to the unwinding shaft 32 via a shaft 20b and plural gears 20c. In this embodiment, the power of the conveyance device 20 is transmitted to the unwinding shaft 32 via three gears 20c.

The number of gears 20c is not particularly limited. A mechanism for transmitting the power of the conveyance device 20 to the unwinding shaft 32 is not limited to such a form. The gear 20c that transmits the power of the conveyance device 20 does not necessarily have to be provided. For example, the conveyance device 20 may be disposed on an axis of the unwinding shaft 32, and a shaft extending from the conveyance device 20 may be connected directly to the unwinding shaft 32. The gears 20c are housed in an atmospheric box 20d provided in the outer wall 31. The atmospheric boxes 20a and 20d are supported by a support plate 33a. A bearing that rotatably supports the unwinding shaft 32 may be attached to the support plate 33a.

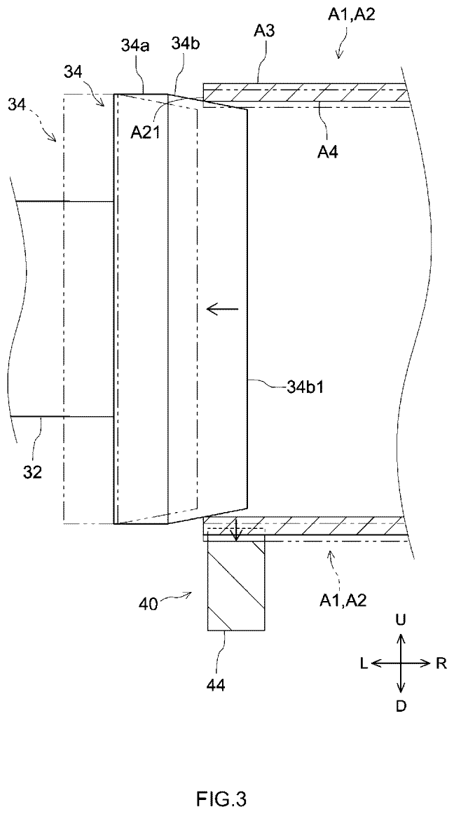

FIG. 3 is a schematic diagram illustrating a retaining structure of the core A2. FIG. 3 illustrates the retainer 34 and the left end portion A21 of the core A2 retained by the retainer 34. In FIG. 3, the core A2 and the retainer 34 are indicated by dash-double-dot lines when the retaining provided by the retainer 34 is released.

As illustrated in FIG. 3, the retainer 34 has an end portion 34a and a tapered portion 34b. The end portion 34a is a substantially disk-shaped portion. The unwinding shaft 32 is connected to substantially the center of the end portion 34a from the left side. The tapered portion 34b is provided on the side (right side) opposed to the retainer 36. The tapered portion 34b is a portion of the retainer 34 that supports the core A2. The tapered portion 34b of the retainer 34 has a diameter decreasing toward the other retainer 36. The tapered portion 34b has a tapered shape in which the diameter decreases toward the retainer 36, and it is substantially in the shape of a truncated cone. A tip surface 34b1 of the tapered portion 34b of the retainer 34 is a flat surface. By having the flat tip surface 34b1 at the tip of the tapered portion 34b, the length of the tapered portion 34b is shortened. This allows the retainer 34 to switch between retention and release simply by slightly moving it in the left-right direction. The tapered portion 34b retains the core A2 from an inner circumferential surface A4 while being inserted into the core A2.

As illustrated in FIG. 2, the retainer 36 has an end portion 36a and a tapered portion 36b. The retainer 36 has a diameter decreasing toward the other retainer 34. The retainer 36 has substantially the same shape as the retainer 34, and thus its detailed illustration is omitted. The tapered portion 36b retains the right end portion A22 of the core A2. A driven shaft 32a is connected to substantially the center of the end portion 36a from the right side. The driven shaft 32a is rotatably supported by a support plate 33b. The driven shaft 32a rotates in a driven manner with respect to the rotation of the unwinding shaft 32 via the core A2.

The retainer 34 connected to the unwinding shaft 32 and the retainer 36 connected to the driven shaft 32a are driven by the drive device 100.

### <Drive Device 100>

The drive device 100 drives the pair of retainers 34 and 36 along the direction in which the retainers 34 and 36 are opposed to each other. In this embodiment, the drive device 100 drives the support plates 33a and 33b. The pair of retainers 34 and 36 is driven through the support plates 33a and 33b, respectively. The drive device 100 drives the pair of retainers 34 and 36 in the direction in which the retainers 34 and 36 are approaching or moving away from each other.

The drive device 100 includes a motor 101, a ball screw 102, guide rails 103 and 104, and sliders 105 and 106. The motor 101 rotationally drives the ball screw 102 along a circumferential direction of the ball screw 102. The motor 101 and the ball screw 102 may be connected to each other via a coupling, a bearing, or the like. The ball screw 102 extends along the direction (axial direction of the core A2) in which the retainers 34 and 36 in a pair are opposed to each other. Two ball nuts (not illustrated) are screwed onto the ball screw 102. The two ball nuts are configured to move in different directions from each other as the ball screw 102 rotates. For example, the orientations of female threads of the two ball nuts or the orientations of male threads of the ball screw 102 onto which the two ball nuts are screwed may be set in different directions.

The guide rails 103 and 104 extend along an opposed direction (axial direction of the core A2) in which the retainers 34 and 36 in a pair are opposed to each other. The guide rail 103 is provided on a base 31a provided on a floor surface of the unwinding unit 30. The guide rail 103 is provided below the retainer 34, while the guide rail 104 is provided below the retainer 36. The sliders 105 and 106 are disposed on the guide rails 103 and 104, respectively. The support plates 33a and 33b with the retainers 34 and 36 attached, respectively, are attached onto the sliders 105 and 106, respectively. The sliders 105 and 106 are configured to be movable along the guide rails 103 and 104, respectively. Each of the sliders 105 and 106 is connected to a corresponding one of the two ball nuts screwed onto the ball screw 102. Thus, the sliders 105 and 106 are driven along the opposed direction as the ball screw 102 rotates. As a result, the retainers 34 and 36 are driven along the opposed direction.

When the pair of retainers 34 and 36 retains the core A2, the drive device 100 drives the pair of retainers 34 and 36 along the opposed direction (the direction in which the retainers 34 and 36 in a pair approach each other). When the pair of retainers 34 and 36 retains the core A2, the tapered portion 34b of the retainer 34 is inserted to the inner circumferential surface A4 (see FIG. 3) of the core A2 (the retainer 36 is configured in the same manner as the retainer 34). When the pair of retainers 34 and 36 releases the retention of the core A2, the drive device 100 drives the pair of retainers 34 and 36 along the direction opposite to the opposed direction (the direction in which the retainers 34 and 36 move away from each other). At this time, as illustrated in FIG. 3, the retainer 34 is driven in the direction indicated by the arrow in the figure (the above-mentioned opposite direction), and the tapered portion 34b is pulled out from the end portion A21 of the core A2. Similarly, the retainer 36 is driven along in the direction away from the retainer 34, and the tapered portion 36b is pulled out from the end portion A22 of the core A2 (see FIG. 2). With this configuration, the retention and release of the core A2 using the pair of retainers 34 and 36 can be easily switched.

As illustrated in FIG. 2, a pair of support parts 40 and 50 is provided below both end portions A21 and A22 of the core A2 retained by the pair of retainers 34 and 36, respectively.

### <Pair of Support Parts 40 and 50>

The pair of support parts 40 and 50 serves as members that receive the end portions A21 and A22 of the core A2, respectively. When the pair of retainers 34 and 36 retains the core A2, the end portions A21 and A22 of the core A2 are supported by the support parts 40 and 50, respectively. When the retention of the core A2 is released, both end portions A21 and A22 of the core A2 are lifted from the support parts 40 and 50. The heights of the support parts 40 and 50 are not particularly limited as long as their heights are set to enable switching between the retention and release of the core A2 in accordance with the driving of the pair of retainers 34 and 36. In this embodiment, the pair of support parts 40 and 50 is set at the height where the upper end portion of the inner circumferential surface A4 of the core A2 is higher than the upper end portions of the tips of the tapered portions 34b and 36b of the pair of retainers 34 and 36 when the support parts 40 and 50 support the core A2.

In the embodiment described above, the heat treatment apparatus 10 includes the conveyance device 20, the unwinding unit 30, the heat treatment unit 90, and the winding unit 60. The conveyance device 20 conveys the strip-shaped workpiece A. The unwinding unit 30 unwinds the workpiece A. In the heat treatment unit 90, the unwound workpiece A is heat-treated while being conveyed along the predetermined conveyance route. The winding unit 60 winds up the processed workpiece A. The unwinding unit 30 includes the pair of retainers 34 and 36 and the pair of support parts 40 and 50. The pair of retainers 34 and 36 retains the core A2 of a roll (here, the unwinding roll A1), on which the workpiece A is wound, from both sides thereof in the axial direction. The pair of support parts 40 and 50 receives the end portions A21 and A22 of the core A2 below both end portions A21 and A22 of the core A2 retained by the pair of retainers 34 and 36, respectively. In the embodiment described above, the unwinding unit 30 includes the pair of retainers 34 and 36 and the pair of support parts 40 and 50, but the winding unit 60 may include the pair of retainers 34 and 36 and the pair of support parts 40 and 50.

When replacing a roll (in this embodiment, the unwinding roll A1), the core A2 can be retained by the pair of support parts 40 and 50 respectively provided below the two end portions A21 and A22 of the core A2. By providing the pair of support parts 40 and 50 below both end portions A21 and A22 of the core A2, respectively, the roll can be smoothly transferred between the pair of retainers 34 and 36 and the pair of support parts 40 and 50. For example, in the unwinding unit 30, the unwinding roll A1 on which the workpiece A is unwound may be replaced with a new unwinding roll A1 before the workpiece A is unwound. The weight of the new unwinding roll A1 may be large. The core A2 of the new unwinding roll A1 can be retained by the pair of retainers 34 and 36 in a state where the new unwinding roll A1 is temporarily placed on the pair of support parts 40 and 50. The unwinding unit 30 before the workpiece is unwound may be placed on the pair of support parts 40 and 50 by a lifter or the like. Thus, the workability of roll replacement is enhanced in the unwinding unit 30. In the winding unit 60, the winding roll A6 on which the workpiece A is wound may be replaced with a core of the new unwinding roll before the workpiece A is wound. The weight of the winding roll A6 on which the workpiece A is wound after the processing may be large. After the workpiece A is wound, the winding roll A6 can be temporarily placed on the pair of support parts 40 and 50 by being shifted from the pair of retainers 34 and 36. The winding roll A6 with the workpiece A wound thereon may be delivered from the pair of support parts 40 and 50 by a lifter or the like. Thus, the workability of roll replacement is enhanced in the winding unit 60.

The form of the pair of support parts 40 and 50 is not particularly limited as long as they can retain the core A2.

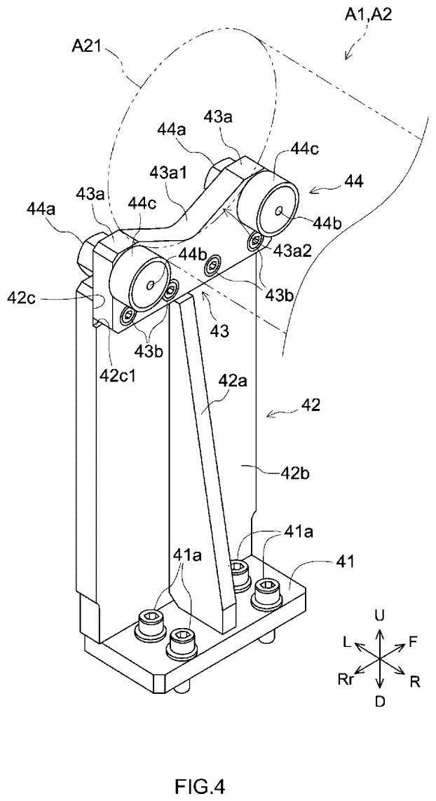

FIG. 4 is a perspective view of the support part 40. In FIG. 4, the core A2 is virtually indicated by dash-double-dot lines. The configuration of the pair of support parts 40 and 50 will be described below by using the configuration of the support part 40 as an example. Since the support part 50 can be configured in the same manner as the support part 40, a detailed description thereof is omitted. As illustrated in FIG. 4, the support part 40 has an attachment portion 41, a first support plate 42, a second support plate 43, and a pair of support rollers 44.

### <Attachment Portion 41>

The attachment portion 41 is a portion that is attached on the base 31a (see FIG. 2) within the unwinding unit 30. The attachment portion 41 is attached onto the base 31a by bolts 41a. The attachment portion 41 is a plate-shaped portion having a substantially rectangular shape. The first support plate 42 extends from one side of the attachment portion 41 (in this embodiment, the left long side) along the height direction of the plate.

### <First Support Plate 42>

The first support plate 42 is a plate-shaped portion having a substantially rectangular shape with its height greater than its width along the front-back direction. The first support plate 42 has a rib 42a along the height direction. The rib 42a is provided on a surface (right-side surface) 42b of the plate-shaped first support plate 42 that faces a support part 50. The rib 42a is provided at the center of the first support plate 42 in the width direction. The rib 42a extends from a top surface of the attachment portion 41 to an upper portion of the first support plate 42. A stepped surface 42c is provided in an upper portion of the right-side surface of the first support plate 42. The stepped surface 42c is thinner than the rest of the first support plate 42. The second support plate 43 is attached to the stepped surface 42c.

### <Second Support Plate 43>

The second support plate 43 is a plate-shaped member attached to an upper portion of the first support plate 42. The second support plate 43 may be removably attached to the first support plate 42. A recess 43al is formed substantially at the center of an upper side 43a of the second support plate 43. By forming the recess 43al in the second support plate 43, the second support plate 43 can be prevented from interfering with the retainer 34. The second support plate 43 is attached to the stepped surface 42c of the first support plate 42 by bolts 43b. The second support plate 43 may be attached to the stepped surface 42c in a manner that allows its position to be adjusted with respect to the stepped surface 42c. The first support plate 42 may have long holes drilled therein into which the bolts 43b are attached. By adjusting the position of the bolt 43b in the long hole, the height of the second support plate 43 may be adjusted. The second support plate 43 is disposed with a spacing of a predetermined distance from the lower edge 42cl of the stepped surface 42c of the first support plate 42. The pair of support rollers 44 is provided at an upper portion of the second support plate 43. The shape or the like of the second support plate 43 is not particularly limited.

### <Pair of Support Rollers 44>

The pair of support rollers 44 are rollers that support the core A2 of the unwinding roll A1. The support rollers 44 are attached at the same height at the front and rear sides of the second support plate 43 by bolts 44a. The support roller 44 is rotatably attached onto the second support plate 43. A rotation axis 44b of the support roller 44 extends along the direction in which the support parts 40 and 50 in a pair are opposed to each other, and it is parallel to the axial direction of the core A2. The support rollers 44 are provided on a surface (right-side surface) of the second support plate 43 that faces the support part 50. The support rollers 44 are provided on the second support plate 43. The core A2 is supported by outer circumferential surfaces 44c of the pair of support rollers 44. When the core A2 rotates in the circumferential direction, the pair of respective support rollers 44 also rotates following the rotation of the core A2.

When the unwinding roll A1 is replaced with a new one, the workpiece A can be unwound from the new unwinding roll A1 after the replacement (the unwinding roll A1 newly supported by the support parts 40 and 50). After the workpiece A is unwound, it can be coupled to the workpiece A that has been unwound from the previous unwinding roll A1 before the replacement or can be coupled to the winding roll A6. The core A2 is supported by the pair of support rollers 44, thus facilitating rotation of the core A2. For example, the core A2 can be rotated manually. During the roll replacement, the workpiece A is unwound manually from the new unwinding roll A1 after the replacement, and it can be coupled to the preceding workpiece A. This can improve the workability of coupling and changing the workpieces A, and the like.

The support part 40 has a guide 43a2 outside the end portion of the core A2 (in this embodiment, the end portion A21). The guide 43a2 is a portion that protrudes upward from the position where the core A2 is supported, outside the end portion A21 of the core A2. In this embodiment, the upper side 43a of the second support plate 43 protrudes upward from the position where the core A2 is supported, and a portion between the upper side 43a and the support roller 44 functions as the guide 43a2. The guide 43a2 provided in the support part 40 prevents the core A2 from falling out and can improve the workability of roll replacement.

In the embodiment described above, the support plate (here, the first support plate 42) has the rib 42a extending along its height direction. Because of this, the durability of the second support plate 43 can be improved. This prevents defects from occurring during roll replacement, even when the roll (here, the newly replaced unwinding roll A1) is heavy or a large load may be applied to the support part 40 during the roll replacement operation.

The above is a detailed description of the technology disclosed herein through the specific embodiments, but those are illustrative only and do not limit the scope of the claims. Accordingly, the technology described in claims includes various variations and modifications of the embodiments described above.

The present specification also includes the following items 1 to 5. The following Items 1 to 5 are not limited to the above embodiments.

### Item 1:

A heat treatment apparatus including:
a conveyance device that conveys a strip-shaped workpiece;
an unwinding unit that unwinds the workpiece;
a heat treatment unit that performs heat treatment on the unwound workpiece while the workpiece is conveyed along a predetermined conveyance route; and
a winding unit that winds the heat-treated workpiece, wherein
at least one of the unwinding unit and the winding unit includes:
a pair of retainers that retains a core of a roll on which the workpiece is wound, from both sides thereof in an axial direction; and
a pair of support parts that receives respective end portions of the core, below both the end portions of the core retained by the pair of retainers.

### Item 2:

The heat treatment apparatus according to Item 1, wherein
the support part has a pair of support rollers supporting the core.

### Item 3:

The heat treatment apparatus according to Item 1 or 2, wherein
the support part has a guide that protrudes upward from a position where the core is supported, outside the end portion of the core.

### Item 4:

The heat treatment apparatus according to any one of Items 1 to 3, wherein
the support part has a support plate extending along a height direction, and
the support plate has a rib extending along the height direction.

### Item 5:

The heat treatment apparatus according to any one of Items 1 to 4, further including:
a drive device, wherein
one of the pair of retainers has a diameter decreasing toward the other retainer,
the drive device drives the pair of retainers along an opposed direction in which the retainers are opposed to each other,
the drive device drives the pair of retainers in the opposed direction, thereby causing the pair of retainers to retain the core, and
the drive device drives the pair of retainers in a direction opposite to the opposed direction, thereby causing the pair of retainers to release retention of the core.

What is claimed is:

1. A heat treatment apparatus, comprising:
a conveyance device that conveys a strip-shaped workpiece;
an unwinding unit that unwinds the workpiece;
a heat treatment unit that performs heat treatment on the unwound workpiece while the workpiece is conveyed along a predetermined conveyance route; and
a winding unit that winds the heat-treated workpiece, wherein
at least one of the unwinding unit and the winding unit includes:
a pair of retainers that retains a core of a roll on which the workpiece is wound, from both sides thereof in an axial direction; and
a pair of support parts that receives respective end portions of the core, below both the end portions of the core retained by the pair of retainers.

2. The heat treatment apparatus according to claim 1, wherein the support part has a pair of support rollers supporting the core.

3. The heat treatment apparatus according to claim 1, wherein
the support part has a guide that protrudes upward from a position where the core is supported, outside the end portion of the core.

4. The heat treatment apparatus according to claim 1, wherein
the support part has a support plate extending along a height direction, and
the support plate has a rib extending along the height direction.

5. The heat treatment apparatus according to claim 1, further comprising:
a drive device, wherein
one of the pair of retainers has a diameter decreasing toward the other retainer,
the drive device drives the pair of retainers along an opposed direction in which the retainers are opposed to each other,
the drive device drives the pair of retainers in the opposed direction, thereby causing the pair of retainers to retain the core, and
the drive device drives the pair of retainers in a direction opposite to the opposed direction, thereby causing the pair of retainers to release retention of the core.
